(19) United States
(12) Patent Application Publication
(10) Pub. No.: US 2018/0250869 A1
(43) Pub. Date: Sep. 6, 2018

(54) Apparatus for Forming Plastic Preforms into Plastic Containers with Change Device in Modular Construction

(71) Applicant: KRONES AG, Neutraubling (DE)

(72) Inventors: Andreas HACK, Dingolfing (DE); Waldemar SUPPES, Neutraubling (DE); Berndt SCHEPP, Wiesent (DE); Juergen SOELLNER, Beratzhausen (DE); Florian GELTINGER, Donaustauf (DE)

(21) Appl. No.: 15/756,907

(22) PCT Filed: Dec. 19, 2016
(86) PCT No.: PCT/EP2016/081775

§ 371 Date: Mar. 1, 2018

(30) Foreign Application Priority Data
Dec. 18, 2015 (DE) 10 2015 122 310.4

(51) Int. Cl. B29C 49/46; B29C 49/48; B29C 49/42

(52) U.S. Cl. CPC B29C 49/46; B29C 2049/024; B29C 49/4205; B29C 49/48

(57) ABSTRACT

Apparatus for forming plastic preforms into plastic containers with a transport device which transports the plastic preforms along a predefined transport path, wherein the transport device has a movable station carrier on which a plurality of forming stations are arranged, wherein these forming stations each have blow-moulding devices, each forming cavities within which the plastic preforms can be formed into plastic containers, and the blow-moulding devices are arranged on respective blow-mould carriers, wherein the apparatus has a clean room inside which the plastic preforms can be formed into the plastic containers, isolated from a non-sterile environment by at least one wall. The apparatus has a change device which is suitable and intended for at least removing the blow-moulding devices from their blow-mould carriers and/or arranging blow-moulding devices on the blow-mould carriers, wherein this change device is integrated in a module which can be separated from the clean room.

The present invention relates to an apparatus and a method for forming plastic preforms into plastic containers. Such devices and methods have been known from the prior art for a long time. Normally, plastic preforms are heated and then formed into plastic containers in a forming device, such as for example a blow-moulding machine or stretch blow-moulding machine. Recently, also forming devices have become known in which this forming process, for example a stretch blowing-moulding process, is performed under sterile conditions or inside a clean room. The present invention relates also (but not exclusively) to such sterile blow-moulding machines. It is pointed out that the invention may also be applied to non-sterile machines. In the prior art, in such machines it is usual for the blow-moulding units, for example blow moulds, to be changed frequently. This may for example be necessary for switching.from one container type to another container type, Change devices such as change robots which perform such a change of blow moulds are also known from the prior art.

In sterile blow-moulding machines in particular, such a change of blow moulds is however very complex since a clean room must be opened and then complete resterilisation performed.

The present invention is therefore based on the object of simplifying such change processes, in particular in sterile forming devices. This object is achieved according to the invention by the subjects of the independent claims. Advantageous embodiments and refinements are the subject of the subclaims.

An apparatus according to the invention for forming plastic preforms into plastic containers has a transport device which transports the plastic preforms along a predefined transport path. Here, the transport device has a movable station carrier on which a plurality of forming stations are arranged. These forming stations each have blow-moulding devices, each forming cavities within which the plastic preforms can be formed into plastic containers. Furthermore, said blow-moulding devices are arranged on respective blow-mould carriers, In to addition, the apparatus has a clean room inside which the plastic preforms can be formed into the plastic containers, and this clean room is isolated from a non-sterile environment by means of at least one wall.

According to the invention, the apparatus has a change device which is suitable and intended for at least removing the blow-moulding devices from their blow-mould carriers and/or arranging blow-moulding devices on the blow-mould carriers, wherein this change device is integrated in a module which can be separated from the clean room.

Therefore, according to the invention, it is proposed to provide in the sterile blow-moulding machine a change device, such as for example a change robot, which performs the change of blow-moulding devices at least partly automatically and preferably fully automatically. By corresponding configuration of the clean rooms, and preferably also of a clean room of the change device, it becomes possible that, on a change of blow moulds, the entire clean room is not necessarily contaminated and resterilisation may be omitted or at least simplified in comparison with the prior art. Preferably, the movable carrier on which the forming stations are arranged is a rotatable carrier.

In a further advantageous embodiment, the clean room of the forming device is a clean room which surrounds, in the manner of a channel, the transport path of the plastic preforms to be formed. Preferably, also at least one rotation axis of the carrier on which the forming stations are arranged lies outside the clean room. In this way, the volume of the clean room can be substantially reduced.

In a further advantageous embodiment, the clean room is delimited by at least two walls which are movable relative to each other. A sealing device arid in particular a so-called water lock may be provided between these two movable walls. One of these walls, and in particular a wall arranged radially on the inside, may be formed by the carrier on which the forming stations are arranged.

The present invention is however also applicable to configurations in which the forming device does not have a clean room.

The applicant therefore reserves the right to also claim protection for an apparatus for forming plastic preforms into plastic containers, with a transport device which transports the plastic preforms along a predefined transport path, wherein the transport device has a movable station carrier on which a plurality of forming stations are arranged, wherein these forming stations each have blow-moulding devices, each forming cavities within which the plastic preforms can be formed into plastic containers, and said blow-moulding devices are arranged on respective blow-mould carriers. In contrast to the embodiment described above however, the apparatus here need not have a clean room. According to the invention however, this apparatus also has a change device which is suitable and intended at least for removing the blow-moulding devices from their blow-mould carriers and/or arranging blow-moulding devices on the blow-mould carriers.

Advantageously, the forming device is a blow-moulding machine and in particular a stretch blow-moulding machine. Preferably therefore, the forming device has a rod-like body at each forming station which can be inserted in the plastic preforms in order to extend these in the longitudinal direction.

In a further advantageous embodiment, the forming stations also each have inflating devices which load the plastic preforms with a gaseous medium, arid in particular with blowing air. These inflating devices may be applied to a mouth of the containers in order to expand or inflate these. In particular, these inflating devices are blowing nozzles.

In a further advantageous embodiment, the module of the change device has a carrier element for carrying essential components of the change device, for example a carrier of the robot, and hence indirectly also change devices such as for example change arms.

Preferably, the essential components of the change devices are attached to this carrier element. Mounting elements may be provided here which allow pivotable or rotatable mounting of elements of the change device relative to the carrier element.

In a further preferred embodiment, the change device is a blow-mould change robot.

In a further advantageous embodiment, the change device or the module comprises control devices for controlling the change device. For example, sensor elements may also be provided which detect e.g. positions of the blow-moulding devices, or also allow control of the to change device depending on such detected positions. Advantageously, this control device for the change device is in communication connection with control devices of the blow-moulding machine and/or with control devices of the entire plant for production of containers. In a further preferred embodiment, the change device has at least one gripper device for gripping the blow-moulding devices or parts of the blow-moulding devices, such as the side parts of the blow-moulding device or a base part of the blow-moulding device. This gripper device may be configured as an active gripper device which can be actuated to grip the blow-moulding devices.

In a further advantageous embodiment, the module of the change device comprises protection devices, such as protective walls, which prevent access to the change device. These protection devices may also comprise control devices which for example allow deliberate opening and closing of the protection devices. Thus for example sliding doors or similar could be provided, via which the module of the change device may be supplied with blow-moulding devices to be changed or also magazines for blow-moulding devices.

In a further advantageous embodiment, the apparatus comprises an input device in order to control a blow mould change and/or control the change device. This may for example be an input panel, which may preferably also be arranged outside The clean room or protection devices in order to allow convenient operation of the change device. In addition, it would be possible for such an input panel to communicate wirelessly with a control system of the change device.

In a further advantageous embodiment, openings are provided in the above-mentioned protection devices in order to introduce moulds, i.e. blow-moulding devices, or also mould magazines into a protected area and/or allow access to the forming device.

In a further advantageous embodiment, the module also has stop or fixing points for transporting the module as a whole. Thus for example, it may be possible for the module to be moved as a whole. Hero it is conceivable that the module can be transported along a precisely defined transport path, for example along a rectilinear transport path. Advantageously, the module is movable in a direction in which the heating device extends, or more precisely, parallel to or opposite the direction in which the plastic preforms are transported during heating. It would however also be possible for it to be movable obliquely to this direction.

In a further advantageous embodiment, the module also has supporting feet or machine feet for placing the module on the ground and in some cases fixing it there.

In a further advantageous embodiment, the module has an interface by means of which the module can be attached to a forming device, such as for example a blow-moulding machine. This interface may in particular also have closing mechanisms for creating or interrupting a connection between the change device or the module of the change device and the blow-moulding device. In particular, a corresponding connecting opening is sufficiently large for blow moulds to be introduced through this. Advantageously, this interface may be configured in the manner of a flange. An opening may be surrounded for example by a frame element, onto which in turn a corresponding frame element of the interface or change device module can be connected, or a connection created.

Particularly preferably, this interface allows a connection to the clean room of the forming device such that the sterility of the clean room can be maintained. Thus the interface may in particular allow a connection which is sealed against a (non-sterile) environment.

In a further advantageous embodiment, the change device or module has electric hardware components which can control all essential functions of the change device. In addition, preferably electric hardware components are provided which allow an exchange of signals between the robot controller and/or the safety device and/or any actuators and sensors, and a general control system of the blow-moulding machines and plant. Preferably, the change device has at least one actuator device selected from a group of actuator devices which contains electrically operated actuator devices, pneumatically operated actuator devices, hydraulically operated actuator devices, magnetically operated actuator devices, and similar.

In a further advantageous embodiment, the carrier element of the module is configured in sandwich construction. Thus a lower belt, an upper belt and ribs may be provided in order firstly to achieve high strength, but secondly also a low weight and low costs. Advantageously, the interface to the forming device is configured to be sealed against sound m and vision, and in particular preferably movable electrically and/or pneumatically and/or hydraulically. In a preferred embodiment, the operating device and/or the control device may be positioned below the actual change device, so that the operating side protrudes from the protected area and allows operation from outside.

It is therefore proposed in general that the mould changing system or change device is configured as an independent module.

In a further advantageous embodiment, the apparatus has a heating device which heats the plastic preforms. This heating device is preferably connected upstream of the forming device.

In a further advantageous embodiment, the change device module is oriented parallel to this oven for the plastic preforms (and preferably also movable in this parallel direction). Advantageously, here the individuall components of the change device or the entire system are arranged in a line running parallel to the heating device. For example, the middle of a blowing wheel or the rotatable carrier may be arranged on this line, together with a centring unit which serves for centring the blowing wheel during a change process. Also, a device for opening the blow-moulding device may be arranged on this line, and also the change device itself, arid in some cases also a magazine device for storing blow moulds. This arrangement allows a very compact construction of the plant.

Particularly preferably, the change device is configured such that blow-moulding devices and/or magazines with blow-moulding devices are loaded and unloaded in the predefined direction of the change device module. Thus for example a user may supply the change device with a magazine with blow-moulding devices along this line or preferably in a direction running parallel to the oven.

In a further advantageous embodiment, the change device is arranged inside a lock room which can preferably be brought into connection with the clean room of the forming device. In this way, it is thus proposed that a lock room is provided, inside which the change devices are located, and where applicable together with further devices such as a magazine for blow-moulding devices. Here it is possible that the module of the change device itself forms this lock room. The lock room can preferably be isolated from a (non-sterile) environment, and to preferably also isolated gas--tightly in order to maintain sterile conditions inside this lock room.

In a further advantageous embodiment, the apparatus has a closing mechanism to close a connection between the lock chamber and the clean room. In this way, during working mode of the forming device for example, the change device can be decoupled gas-tightly from the clean room, and for example the change device or module fitted with a new magazine for blow-moulding devices. This closing Mechanism may for example be a closable flap, a roller shutter or similar which can be closed (in particular for decoupling of the change device).

In a further advantageous embodiment, the change device has a magazine device for receiving blow-moulding devices. This procedure allows the semi- or fully automatic change of blow moulds. Thus for example, the machine operator may supply the change device module with such a magazine device, and then the change device itself performs the change.

In a further advantageous embodiment, the apparatus has a device for loading the lock room with a sterilisation medium. In this way, for example after a change has been performed, the lock room can be resterilised. Advantageously, the sterilisation medium is a gaseous hydrogen peroxide (H₂O₂), preferably a gaseous hydrogen peroxide in low concentration.

In a further embodiment, it would be possible for the apparatus to have a sterilisation device for sterilising plastic containers and in particular plastic preforms. The advantage of sterilising the plastic preforms is that these have still a small surface area and therefore can be sterilised with less sterilisation medium. Advantageously, such a sterilisation device is arranged between a heating device and the forming device.

This sterilisation device may preferably have an outlet air line which discharges gas which (still) charged with sterilisation medium. This outlet air line may be used to resterilise the lock room.

It would thus be conceivable that the above-mentioned lock room is opened in order to supply a magazine) device to this. Then the lock room is closed. In this closed state, the interior of the lock room and/or the elements arranged therein (in particular the change device, the magazine device and in some cases the blow-moulding devices themselves) can he resterilised. After this process has been concluded, a connection between the clean room of the forming device and the lock device can he opened and the change device can perform the change of blow-moulding devices.

In a further advantageous embodiment, the change device module has a protection element for isolating the module from the environment. Thus it is possible that the change device module itself can form a room which is fully isolated from the environment. In particular, this may be the above-mentioned lock room. This may be advantageous in particular for performance of a blow mould change, since in this case the change device module can be connected directly to the clean room of the forming device. These protection elements may for example be walls which particularly preferably are not gas-permeable.

Here too, the change device is integrated in an autonomous change device module. This change device module may here again have isolating walls which surround this module. In this embodiment however, advantageously, no cover portion is provided, i.e. the working room in which the change device is working may preferably be open at the top.

In a further advantageous embodiment, the change device module is movable relative to the forming device.

Preferably, the change device has an identification device which serves for identifying blow moulds and/or blow--mould parts. This identification device may have a detection device, for example an RFID detection device. In particular however, advantages also result for a sterile configuration, since in change mode, the blow--moulding devices can be identified in particular contactlessly and without opening the above-mentioned lock room.

The embodiments described above and below may, where they do not relate to sterility, also be used for the non-sterile configuration.

In a further advantageous embodiment, at least one blow-moulding device has an RFID element which can be read by an RFID detection device.

Preferably, the change device has a position detection device for detecting a geometric position of blow-moulding devices and/or blow-mould parts. This may also be advantageous for a sterile machine, since in this case collisions or incorrect positions may also be detected or corrected without requiring the intervention of a user in a clean room.

The present invention furthermore relates to a method for operating a forming device for forming plastic preforms into plastic containers. Here, in a working mode of the apparatus, the plastic preforms are transported by means of a plurality of forming stations along a predefined transport path, and by loading with a fluid medium are expanded into plastic containers. Here, to expand the plastic preforms, blow-moulding devices are used, inside which the plastic preforms are expanded into plastic containers, wherein in a change mode, at least one of the blow-moulding devices is removed from the apparatus and/or one of the blow-moulding devices is arranged on a blow-mould carrier of the apparatus. According to the invention, to change the blow-moulding devices, a change device is used and this change device is integrated into a module which can be separated from the forming device.

Therefore according to the method, it is proposed that the change device is integrated into a separate module.

Advantageously, the plastic preforms are expanded into the plastic containers inside a clean room, and this clean room is preferably separated or sealed from an environment by at least one wall.

In a further advantageous embodiment, the module of the change device forms a lock room. It is preferably possible here that this lock room is also, at least for part of the time, completely sealed from the environment and hence it becomes possible for blovv mould devices to be changed without contaminating the clean room of the blow-moulding rnachine. Preferably, this lock room is under a positive pressure for at least part of the time, i.e. more precisely a positive pressure relative to ambient pressure. Here it is possible that also a clean room of the forming device stands under a positive pressure relative to the (non-sterile) environment. Preferably, a pressure inside a clean room of the forming device is greater than a pressure inside the lock room, so that preferably, on opening of a connection between the clean room and the lock room, the gas flow runs from the clean room into the lock room.

In a further preferred method, at least one gripper device of the change device grips a blow-moulding device in an upper region relative to a longitudinal direction of the blow-moulding device. In this embodiment it is possible that, for the change process, first the blow-moulding device is gripped by a gripper device and then the blow-mould carrier opened, so that said blow mould can be removed from the machine.

In a further preferred method, a positioning of at least one blow-moulding device is detected. In this way, secure changing of the blowmoulding devices is possible.

Further advantages and embodiments arise from the enclosed drawings. These show:

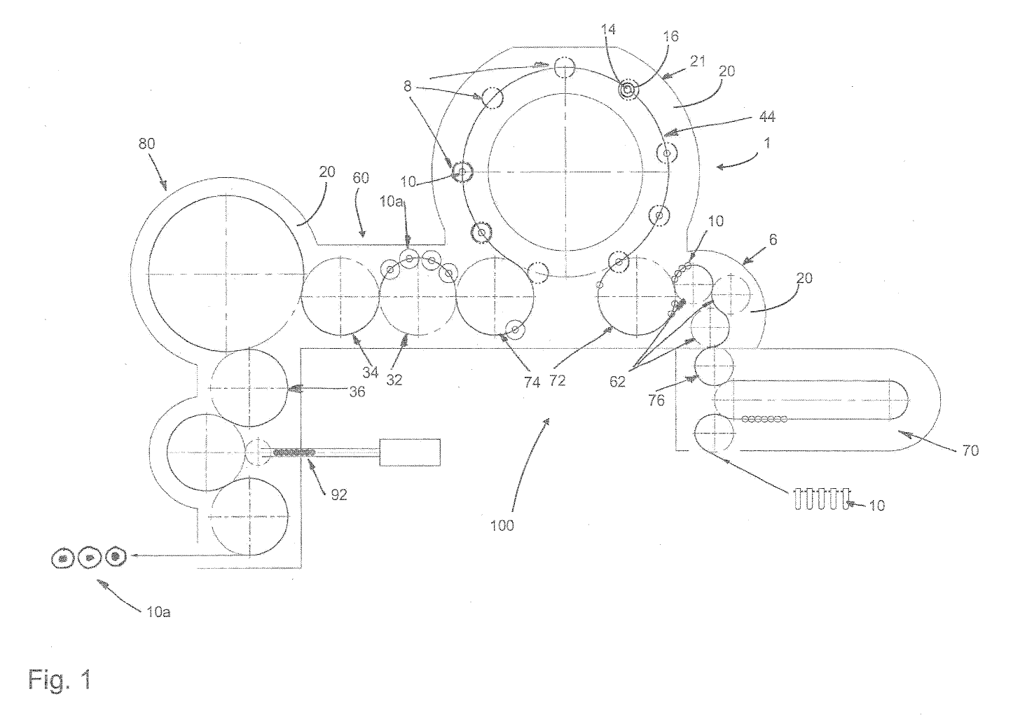

FIG. 1 a diagrammatic depiction of an apparatus according to the invention for producing plastic containers;

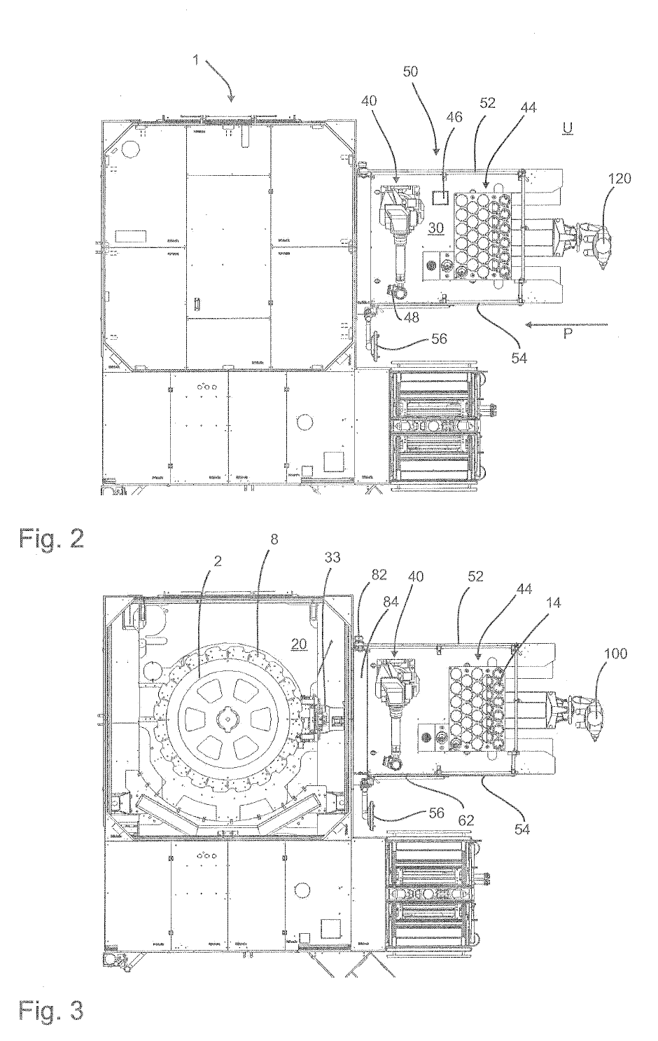

FIG. 2 a depiction of an apparatus according to the invention with change device;

FIG. 3 a further depiction of a blow-moulding device with change device; and

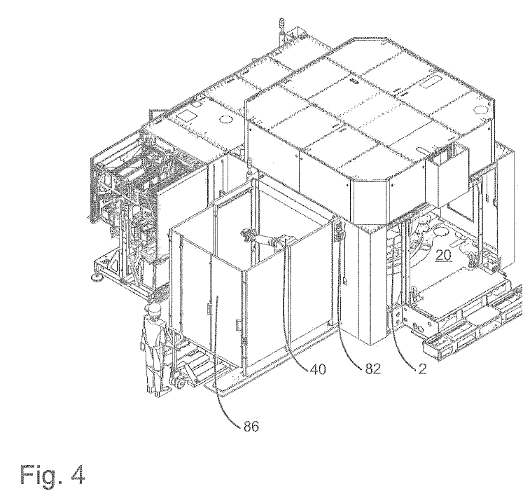

FIG. 4 a perspective view of a blow-moulding machine with change device.

FIG. 1 shows a diagrammatic depiction of a plant 100 for producing plastic containers. A heating device 70 is provided, into which plastic preforrns 10 are introduced. Inside this heating device 70, which in particular is an infrared oven, the plastic preforms are heated and then discharged with a transport device 76 such as a discharge wheel. Instead of an infrared heating device however, a microwave heating device could also be used. It would also be possible for an injection moulding machine to be provided which produces plastic preforms 10.

Reference sign 6 designates a sterilisation device which serves to sterilise the plastic preforms 10. A clean room 20 is already formed in the region of the sterilisation device 6. After sterilisation, the plastic preforms 10 are transferred via a transport star 72 to the actual forming device 1. This forming device 1, as stated above, comprises a plurality of forming stations or blowing stations 8 which load the plastic preforms 10 with blowing air to expand them. This forming also takes place inside the clean room 20. The clean room is here to isolated from an environment by means of a wall 21. Reference sign 44 designates the transport path of the plastic containers during their expansion. This transport path preferably runs in a circle. Each forming station here has a blow-mould carrier 16 (shown merely diagrammatically) on which a blow-moulding device 14 is arranged. This blow-moulding device here preferably consists of two side parts and a base part

The now finished containers 10a are discharged by means of a discharge star 74. Then the containers 10a are transported further by means of transport devices 32 and 34, and in particular transported to a filler device 80 in which they are filled. Optionally, it would also be conceivable here to provide a sterilisation device 60 which sterilises the containers 10a. Reference sign 92 designates a supply device vvhich supplies closures to the containers in order to close them. Reference sign 36 designates a transport device which transports the filled containers from the filler device 80 to the closing device.

FIG. 2 shows a diagrammatic depiction of an apparatus 1 according to the invention with change device. Here, the heating device is still only shown partially or diagrammatically. This apparatus here comprises the change device, designated as a whole with sign 50, or the module 50 with the change device 40. The change device forms a lock room 30 which is surrounded by several walls 52 and 54. The actual change robot 40 has a gripper device 48 which serves to grip the blow-moulding devices. Reference sign 56 designates an operating device such as a touch panel which serves to operate the change device 40 without needing to penetrate the lock room 30.

Reference sign 44 designates a magazine device in which blow-moulding devices are received. It is evident that a user 120 may advance this magazine device 44 in a predefined direction P. This direction here runs parallel to longitudinal direction of the heating device. To introduce the magazine 44, ea wall delimiting the lock morn 30 may be opened.

In addition, the nodule 50 also has a cover in order to delimit the lock room 30 completely. Reference sign 46 indicates roughly diagrammatically a device for applying a sterilisation medium to the lock room or to elements present in the lock room 30, such as the magazine device 44 or the change device 40. It would be possible for a plurality of such devices which serve for sterilisation to be provided inside the lock room.

FIG. 3 shows a more detailed depiction of the apparatus according to the invention. Here we see the transport device 2 on which the individual forming stations 8 are transported. Reference sign 33 designates a centring device which positions the transport device 2 relative to the change device 40 or the gripper arm 48. Reference signs 82, 84 designate a connecting device via which the lock room 30 or the change module is coupled to the blow-moulding device. Via this connecting device, a connection can be created between the two regions. This connection is preferably gas-tight against the environment U. Furthermore, preferably, a closing mechanism is provided with which the connection between the lock room 30 and the clean room 20 of the forming device can be interrupted. Reference sign 14 designates an individual blow-moulding device. The lock room 30 can also be opened via a connecting door 62 so that the user is able to intervene. Preferably, a closing mechanism is provided on the side of the module 50 in order to delimit the lock room, and also on the side of the forming device 1. Thus it would be possible that these two closing mechanisms not shown) are closed and then the module 50 removed from the forming device 1 without having to open the clean room 20 or the lock room 30.

FIG. 4 shows a perspective view of the apparatus according to the invention. Here again, a door 88 can be seen which may be opened so that the user can introduce a magazine device into tire lock room 30. The cover portion delimiting the lock room is not shown here.

The applicant reserves the right to claim as essential to the invention all features disclosed in the application documents insofar as they are novel individually or in combination in relation to the prior art. It is also pointed out that features are described in the individual figures which may be advantageous taken in themselves. The person skilled in the art will immediately understand that a specific feature described in one figure may also be advantageous without using further features this figure. Furthermore, the skilled person will find that advantages may also be obtained by a combination of several features shown in individual or in different figures.

### LIST OF REFERENCE SIGNS

2 Transport device
6 Sterilisation device
8 Forming stations
10 Plastic preforms
10a Containers
14 Individual blow-moulding device
16 Blow-mould carrier
20 Clean room
21 Wall
30 Lock room
32, 34, 36 Transport devices
33 Centring device
40 Change robot
44 Transport path/magazine device
48 Gripper device
50 Change device
52, 54 Walls
56 Operating device/touch panel
60 Sterilisation device
62 Connecting door
70 Heating device
72 Transport star
74 Discharge star
76 Transport device
80 Filler device
82, 84 Connecting device
86 Door
92 Supply device
100 Plant
120 User
P Predefined direction

1. An apparatus for forming plastic preforms into plastic containers with a transport device which transports the plastic preforms along a predefined transport path, wherein the transport device has a movable station carrier on which a plurality of forming stations are arranged, wherein these forming stations each have blow-moulding devices, each forming cavities within which the plastic preforms can be formed into plastic containers, and said blow-moulding devices are arranged on respective blow-mould carriers, wherein the apparatus has a clean room inside which the plastic preforms can be formed into the plastic containers, and this clean room is isolated from a non-sterile environment by means of at least one wall,
wherein
the apparatus has a change device which is suitable and intended for at least removing the blow-moulding devices from their blow-mould carriers and/or arranging blow-moulding devices on the blow-mould carriers, wherein this change device is integrated in a module which can be separated from the clean room, and the change device is arranged inside a lock room which can be brought into connection with the clean room of the forming device, wherein the module of the change device itself forms this lock room, and the change device is situated inside the lock room with further devices such as a magazine for blow-moulding devices, and the lock room can be isolated gas-tightly from a (non-sterile) environment in order to be able to maintain sterile conditions inside this lock room.

2. The apparatus according to claim 1, wherein
the apparatus has a closing mechanism to close a connection between the lock chamber and the clean room.

3. The apparatus according to claim 1, wherein
the change device has a magazine device for receiving blow-moulding devices.

4. The apparatus according to claim 1, wherein
the apparatus has a device for loading the lock room with a sterilisation medium.

5. The apparatus according to claim 1, wherein
the apparatus has a sterilisation device for sterilising plastic preforms or plastic containers.

6. The apparatus according to claim 1, wherein
the module has a protection element for isolating the module from the environment.

7. The apparatus according to claim 1, wherein
the module is movable relative to the forming device.

8. A method for operating a forming device for forming plastic preforms into plastic containers, wherein in a working mode of the apparatus, the plastic preforms are transported by a plurality of forming stations along a predefined transport path, and by loading with a fluid medium are expanded into plastic containers, wherein to expand the plastic preforms, blow-moulding devices are used, inside which the plastic preforms are expanded into plastic containers, wherein in a change mode, at least one of the blow-moulding devices is removed from the apparatus and/or one of the blow-moulding devices is arranged on a blow-mould carrier of the apparatus,
wherein
to change the blow-moulding devices, a change device is used and this change device is integrated in a module which can be separated from the clean room, and the change device is arranged inside a lock room which can be brought into connection with the clean room of the forming device, wherein the module of the change device itself forms this lock room, and the change device is situated inside the lock room with further devices such as a magazine for blow-moulding devices, and the lock room can be isolated gas-tightly from a (non-sterile) environment in order to be able to maintain sterile conditions inside this lock room.
